(19) United States
(12) Patent Application Publication
(10) Pub. No.: US 2007/0205650 A1
(43) Pub. Date: Sep. 6, 2007

(54) Seat Belt Buckle Extender

(76) Inventor: Elisabeth Weinstein, Ann Arbor, MI (US)

Correspondence Address: MESMER & DELEAULT, PLLC, 41 BROOK STREET, MANCHESTER, NH, 03104, US

(21) Appl. No.: 11/677,437

(22) Filed: Feb. 21, 2007

Related U.S. Application Data
(60) Provisional application No. 60/777,762, filed on Mar. 1, 2006.

(51) Int. Cl. B60R 22/00

(52) U.S. Cl. 297/469

(57) ABSTRACT

A seat belt buckle extender and method enhances convenience and decreases problems associated with using safety restraints with child booster seats. The seat belt buckle extender has a seat belt latch plate on one end and a seat belt buckle on an opposite end. The extender has an additional lengthening segment to improve the position of the buckle relative to the child booster seat.

This application claims the benefit of provisional application 60/777,762, filed Mar. 1, 2006.

### BACKGROUND OF THE INVENTION

1. Field of the Invention

The present invention relates to automotive safety restraints. Particularly, the present invention relates to automotive safety restraints and their use with child booster seats, and teaches devices and methods to improve the convenience and decrease the difficulty of using safety belts for children.

2. Description of the Prior Art

It is well established that the use of restraints worn across the lap and chest, commonly referred to as “seat belts” increases the safety of individuals driving in motor vehicles, both for operators and passengers. In the United States, all states have laws regarding the use of such restraints, some “primary” meaning that a citation can be written whenever a policeman sees a moving car without a seat belt being used, and the rest “secondary” meaning an officer cannot intervene for not using seat belts, but can issue a citation for not doing so if the vehicle is stopped for another reason.

Special apparatus designed for infants and children under 30-40 pounds are in common use. These are generally secured directly to the seat of the vehicle, and the child is held within them by appropriately sized and configured restraints of the apparatus. For older children over 30-40 pounds, booster seats that position the child to appropriately utilize adult seat belts are recommended for automotive safety. All states require safety seats for children under four years old, and many states require older children to use car booster seats, some mandating booster seat use up to age eight. The National Highway Traffic Safety Administration (NHTSA) recommends the use of booster seats for all older children up to fifty-seven inches in height. Despite encouragement by safety organizations such as the NHTSA, use of booster seats between ages 4-8 has been reported to be below 20%, compared to greater than 80% compliance before age 4. Because booster seats are known to lessen morbidity and mortality in the event of an accident, getting children into booster seats is a present challenge and measures to facilitate ease and convenience of use of booster seats are desirable to foster compliance with using them.

Some booster seats consist essentially of a child-sized seat on a low raised platform. An example of such a basic child booster seat is the Graco TurboBooster (Model 8491SCT) produced by Graco Children's Products of Exton, Pa. This model has no back, and the child's back rests against the back of the vehicle seat. The Graco TurboBooster model incorporates armrests that also serve to position the child in the seat, and it is indicated by Graco to be appropriate for children between the ages of 3 and 10 years old, who weigh between 30 and 100 pounds, are between 38 and 57 inches in height, and whose ears are below the top of the vehicle seat cushion/headrest. The booster seat is placed freely upon the vehicle seat, and the child and booster seat are secured by buckling the seat belt of the vehicle about the child. Other example of child booster seats without backs, and similar in design to the Graco TurboBooster are the Cosco Ambassador (Model 220296-WAL) produced by Cosco, a division of Dorel Industries, Montreal, Canada, and Evenflo Big Kid (Model 2791694) produced by Evenflo Corporation of Piqua, Ohio.

Some booster seat models are more elaborate and have backs, and these are exemplified by the Graco TurboBooster SafeSeat (Model 10-8673FIC), and Britax Parkway (Model E904157) produced by Britax Corporation, Charlotte, N.C. The Graco TurboBooster SafeSeat model has armrests, whereas the Britax Parkway is a model that does not. The molded back configuration of the Britax booster seat helps to position the child.

All booster seat models herein described and referred to, sit freely on the vehicle seat and when in use, both the child and seat are strapped, as a unit, by the vehicle seat belt. In concept, the seat belt serves to limit the motion of both the child and the booster seat in a forward crash. When the child is then thrown forcefully back, the unfixed booster seat is thought to act as a buffer to cushion the child's rebound. This is opposed to the child being thrown forward and away from a seat that is fixed to a vehicle, in which case the seat would not cushion the rebound. Both backless and backed booster seats appear to operate this way in a collision, and there is limited data to suggest enhanced safety of one design over another. When booster seats are used, it is desirable that the positioning of restraints for children be the same as for an adult, that is, for the lap portion of the restraint to fit snugly cross the child's lap, and the “shoulder” portion of the restraint to cross the collar bone (not the face or throat) and chest.

The process of “buckling” an automotive seat belt involves inserting a “latch plate,” typically a flat metal configuration at the end of retractable seat belt webbing, into a “clasp,” “latch,” or “buckle” (synonymous) that is anchored to the body of the vehicle. The latch plate and the buckle are secured together by a clasping mechanism within the buckle, and the latch plate is released by a release mechanism within the buckle. Such devices are well known in the art.

The process of putting a child in a booster seat involves first positioning the booster seat on the vehicle seat, seating the child upon it, drawing the seat belt across the child and booster seat and finally inserting the seat belt latch plate into the seat belt buckle to buckle the belt about both the child and booster seat.

The present invention derives from a recognition that buckling a child in a booster seat belt poses difficulties that result from the ordinary position of automotive seat belt buckles. Seat belt buckles are typically positioned at the level of the junction of the seat and seat back of the vehicle, slightly above this level, or slightly recessed. This does not ordinarily pose a problem for adult use, as an adult can visualize the buckle, and slide the latch plate into the buckle with one hand or also use two hands, one to hold the buckle steady. It is recognized that when a booster seat is placed next to a seat belt latch that is at the approximate level of the junction between the vehicle seat and seat back, the interposed booster seat renders the latch visually obscured and considerably harder to physically access. An individual wishing to secure a child into a seat belt is required to look over both the child and the booster seat to find the buckle, as it cannot be readily seen over the booster seat and child's legs. The individual must then reach one or both arms over the child and the booster seat, to insert the latch plate into the buckle. The problem is amplified by booster seats that have armrests that further obscure view and manual access to the buckle. Such difficulties with buckling a child in a booster seat are worsened if the child is squirming. An alternative to leaning into the vehicle and over the child would be for the individual to place the child into the booster seat, close the vehicle door, and enter the other side of the vehicle, in order to better visualize and access the buckle. This has the drawback of leaving the child alone in the vehicle momentarily. By the time the individual reaches the other side, the child may get out or, perhaps if half-asleep, fall out of the seat. Moreover, this is not a workable option if there are a number of intervening child seats and/or children seated.

In the event of two or three child seats abutting each other, finding the seat belt buckles requires manual separation of the child seats. Further, buckling a child into a seat may require reaching into a narrow space between adjacent child seats to “fish” for the position of the buckle, or contorting to hold the seats apart with one hand and attempting to negotiate the latch plate into the buckle with the other. These maneuvers are particularly unwelcome if the child is squirming, or worse yet, screaming, as the latter necessitates placement of the caregiver's ear in proximity to the child's mouth. Last, and importantly, if the buckle is not clearly seen or felt, there is an increased risk of the seat belt not being properly fastened.

The present invention seeks to improve upon these inconveniences and concerns by providing a means to extend the seat belt buckle so that it can be more easily visualized and reached. Despite the widespread use of child booster seats in automobiles and other vehicles, devices to improve upon the aforementioned problems are not presently available for an ordinary user.

### SUMMARY OF THE INVENTION

In view of the foregoing, it is an object of the present invention to teach and provide a device that will improve the convenience, and reduce the difficulty of using child booster seats. Another objective is to provide an extender device that positions a seat belt buckle to where it can be more easily viewed and more manually accessed when putting a child in a booster seat than at present. A further objective of the present invention is to provide a device that decreases the exertion that is now required to buckle a child in a booster seat. Yet another objective is to provide a seat belt device that is relatively simple to use and inexpensive that will improve upon incompatibilities between the design of adult seat belts and the structure of child booster seats. Another objective is to teach a method of making booster seat belts easier to use than at present. This method would include the provision of an extender device that improves upon the position of ordinary automotive seat belt buckles and extends the position of the buckle to where it can be more readily visualized and manually accessed when placing a child in a booster seat.

The present invention achieves these and other objectives by providing a seat belt buckle extender that has a latch plate on one end and a seat belt buckle on an opposite end. The seat belt buckle extender optionally includes a lengthening segment between the latch plate and the seat belt buckle. The seat belt buckle optionally includes a positioning guide that assists to secure the position of the seat belt buckle of the present invention above the surface of the vehicle seat.

In another embodiment, the seat belt buckle extender is in a kit with instructions for the extender's use with a child booster seat.

Other objectives of the present invention will become apparent in the light of the following drawings and detailed description of the present invention.

### BRIEF DESCRIPTION OF THE DRAWINGS

FIG. 1 is a side view depiction of a vehicle seat and seat belt buckle.

FIG. 2 is a side view depiction of a vehicle seat, seat belt buckle, and child booster seat.

FIG. 3 is a side view depiction of an embodiment of a seat belt buckle extender of the present invention.

FIG. 4 is a side view depiction of a vehicle seat, child booster seat, and a seat belt buckle extender attached to a seat belt buckle.

FIG. 5 is a side view depiction of a vehicle seat, child booster seat, and another configuration of a seat belt buckle extender attached to a seat belt buckle.

### DETAILED DESCRIPTION OF THE PREFERRED EMBODIMENT

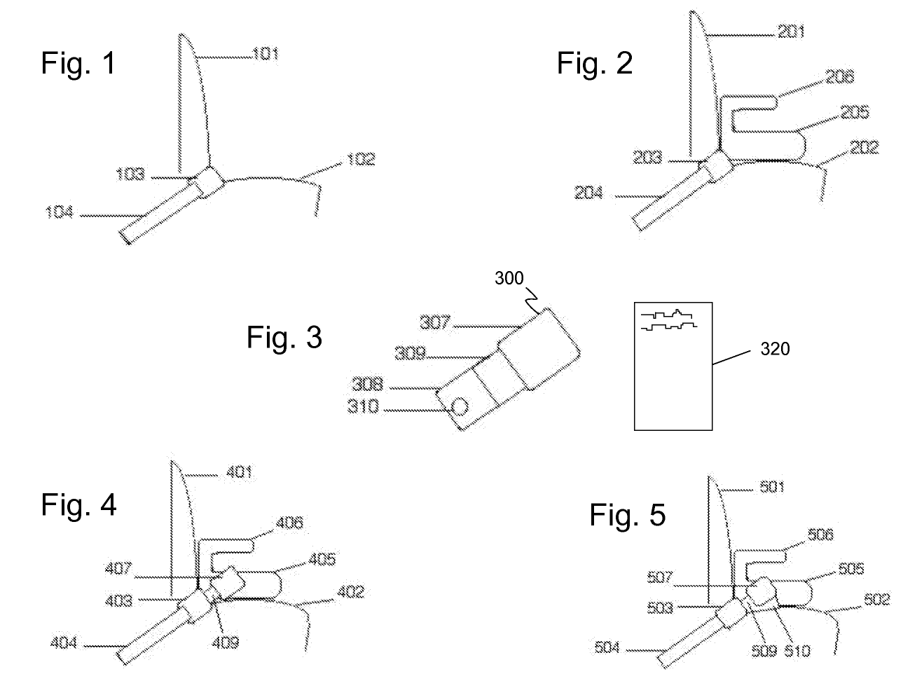

FIG. 1 depicts a side view of a vehicle seat back 101 and seat 102. A seat belt buckle 103 is attached to an anchoring 104 that anchors the buckle to the vehicle. Notably, the seat belt buckle 103, in this instance, is just slightly above the level of the juncture between the seat 102 and seat back 101.

FIG. 2 depicts a side view of a vehicle seat back 201 and seat 202 with a child booster chair having a booster chair seat 205 and armrest 206. As in FIG. 1, a vehicle seat belt buckle 203, attached to an anchoring 204, is depicted to be just above the level of the juncture between the seat and seat back. Notably, the level of the buckle 203 is well below the height of the booster chair seat 205 and its armrest 206, making it difficult to view and reach from the opposite side of the booster chair without leaning and reaching well over the booster chair. The interposition of a child would make the buckle 203 even less accessible to view and reach, and difficult to buckle under direct view.

FIG. 3 depicts an embodiment of a seat belt latch extender 300 of the present invention. The extender 300 itself has a seat belt buckle 307 for receiving the seat belt latch plate of the vehicle seat belt, and a latch plate 308 for insertion of the extender device into the buckle of the vehicle. The latch plate 308 has a grasping provision 310, in this case a circular hole, which allows the latch plate to be grasped by the buckle. It is recognized that latch plates, buckles and grasping provisions of various vehicles come in many configurations, and the latch plate 308 illustrated is necessarily configured to match the configuration of the buckle of the vehicle it is meant to be used with. Accordingly, the buckle 307 of the device is necessarily configured to match the configuration of the latch plate of the vehicle. It can be appreciated that the design and manufacture of devices of the present invention are not within the realm of an ordinary individual, but rather require expertise such as that of an automotive safety engineer or an automotive manufacturer. In some instances, a buckle 307 and attached latch plate 308 alone would suffice to extend the buckle of the device 307 to where it can be comfortably visualized and reached when using a booster seat. In other instances, greater longitudinal extension might be desired. A lengthening segment 309 is illustrated that would provide additional length to the device with the intention of further extending the buckle 307. It is anticipated that the length of a lengthening segment would not be required to exceed approximately eight inches for the present invention to be compatible with most vehicles and booster seats, and that this is largely dependent upon the various configurations of the vehicles with which the device is intended to be used. It is anticipated that the lengthening segment 309 be of relatively inflexible material in keeping with the device being generally and substantially stiff in its longitudinal aspect. It is anticipated that it might be considered desirable to provide a lengthening segment 309 that can be adjusted to adjust for different vehicles. This might be accomplished by constructing a lengthening segment of the device, not as a single longitudinal strip, but of multiple parts held together by mechanical means as are known in the art. Also illustrated are instructions 320 for use with seat buckle extender 300 of the present invention to provide in kit form the extender 300 with instructions 320.

Note is made of devices presently marketed for adult individuals who are too large for conventional seat belts (for example: Auto Seat Belt Extender sold by Wesco Performance, Inc. Camarillo, Calif. and airline seat belt extenders sold by SuperSize World, www.SuperSizeWorld.com). Such seat belt extenders are not configured to extend a seat belt buckle for use with a booster seat nor are they made of materials that would do so. These items, made of flexible seat belt fabric, would not fixedly position a buckle for booster seat use, in contrast to the relatively inflexible longitudinal structure of the present invention.

FIG. 4 depicts a child booster seat 405 with arms 406, in place on a vehicle seat 402 and seat back 401, and illustrates a seat belt buckle extender device of the present invention inserted into the seat belt buckle of the vehicle 403. The buckle 407 of the device, in relation to the booster seat, is seen to be considerably more easily visualized and physically accessible compared to the buckle of the vehicle 403.

FIG. 5 is a side view depiction similar to FIG. 4, and illustrates an embodiment of the present invention in which the device also incorporates a positioning guide 510 to support the buckle 507 in a fixed position above the vehicle seat 502. In this case, the positioning guide 510 extends from the buckle 507 and lengthening segment 509 to the seat 502 and serves to support the seat belt latch 507 at a desirable position for visibility and manual access. The need for such means to secure the positioning of a buckle of the device at a desired location in relation to the booster seat is largely dependent upon the configuration of the buckle of the vehicle. For example, if the vehicle buckle is rigidly attached to the vehicle and if a short device serves to favorably position the buckle of the device, no addition support is anticipated to be required. On the other hand, if the vehicle buckle is not rigidly, but flexibly attached to the vehicle, and/or if a relatively long device is required, additional support might then be required to hold the device buckle above the seat and where desired. Additional guides and adaptations to insure desired positioning of the latch of the device are therefore contemplated, examples being positioning guide configurations that extend from any aspect of the device to the seat, into the crease between the seat and seat back, or while considered less desirable, fixed or reversible attachments to the side of the booster seat.

Various other adaptations to the design of the present invention might be considered desirable and are contemplated, for example configuring the buckle of the invention in order to “funnel” or facilitate insertion of the seat belt latch plate into it and providing padding about the device or the use of soft materials at its surface.

The present invention thus teaches a device to overcome difficulties with using automotive child booster seats and methods for using such devices. While the foregoing embodiments have thus been described to illustrate and exemplify the present invention, various modifications may be made by the artisan upon perusal of this specification, and such changes are intended to be within the scope and spirit of the invention as defined by the claims.

What is claimed is:

1. A vehicle seat belt buckle extender comprising:
a seat belt latch plate; and
a seat belt buckle connected to the seat belt latch plate wherein the seat belt buckle extender is substantially stiff.

2. The extender of claim 1 further comprising a lengthening segment between the seat belt latch plate and the seat belt buckle.

3. The extender of claim 2 wherein the lengthening segment is substantially rigid.

4. The extender of claim 1 further comprising a positioning guide to support the seat belt buckle of the extender in a fixed position above a vehicle seat.

5. A method for enhancing ease of use and decreasing problems with the use of a child booster seat in a automotive vehicle, the method comprising:
obtaining a seat belt buckle extender having a seat belt latch plate and a seat belt buckle connected to the seat belt latch plate;
inserting the seat belt latch plate into the seat belt buckle of a vehicle;
placing a child on a booster seat;
wrapping the seat belt of the vehicle about the seated child; and
inserting the seat belt latch plate of the vehicle into the seat belt buckle of the seat belt buckle extender.

6. A kit for enhancing ease of use and for decreasing problems with the use of a child booster seat in a automotive vehicle, the kit comprising:
a seat belt buckle extender having a seat belt latch plate on one end and a seat belt buckle on an opposite end; and
instructions to insert the latch plate end of the seat belt buckle extender into the seat belt buckle of a vehicle whereby the seat belt buckle extender positions the seat latch end in a more accessible position adjacent the booster seat.

7. The kit of claim 6 wherein the seat belt buckle extender includes a lengthening segment between the seat belt latch plate and the seat belt buckle.

8. The kit of claim 6 further comprising a positioning guide to support the seat belt buckle of the extender in a fixed position above a vehicle seat.
